(19) United States
(12) Patent Application Publication
(10) Pub. No.: US 2020/0089461 A1
(43) Pub. Date: Mar. 19, 2020

(54) MULTI-SCREEN DISPLAY SYSTEM, IMAGE DISPLAY DEVICE, IMAGE DISPLAY METHOD, AND IMAGE DISPLAY PROGRAM

(71) Applicant: NEC Display Solutions, Ltd., Tokyo (JP)

(72) Inventor: Kenji YAMAMOTO, Tokyo (JP)

(21) Appl. No.: 16/496,885

(22) PCT Filed: May 26, 2017
(86) PCT No.: PCT/JP2017/019709

§ 371 Date: Sep. 23, 2019

(51) Int. Cl. G06F 3/14; G09G 5/12; G09G 5/18

(52) U.S. Cl. CPC G06F 3/1446; G09G 5/12; G09G 2300/026; G06F 3/1431; G09G 5/18

(57) ABSTRACT

A multi-screen display system includes a plurality of image display devices daisy-chained together, wherein an image display device further includes a storage unit configured to store at least schedule information representing a schedule to reproduce content, and a content reproduction controller configured to start reproducing the content according to the schedule information and the time information of a master image display device corresponding to one of the plurality of image display devices included in the multi-screen display system, and wherein the time information is sent from the master device to another image display device included in the multi-screen display system.

### TECHNICAL FIELD

The present invention relates to a multi-screen display system, an image display device, an image display method, and an image display program.

### BACKGROUND ART

Recently, image display devices such as liquid-crystal monitors configured to reproduce content by using media players, which are embedded therein and configured to play back content (e.g. multimedia content including videos and sounds), without using external devices configured to play back content (e.g. personal computers) have been widely spread.

A multi-screen display system may include a plurality of image display devices, which are generally daisy-chained together (or linked together in a row) using video signal cables such as HDMI (a registered trademark) (High-Definition Multimedia Interference) cables, DVI (a registered trademark) (Digital Visual Interface) cables, and DisplayPort (a registered trademark) (display-port) cables.

For example, Patent Document 1 discloses a multi-display system including a plurality of display devices which are daisy-chained together and each of which is configured to sequentially transmit video signals and synchronization signals to its latter-stage display devices.

### CITATION LIST

### Patent Literature Document

Patent Document 1: Japanese Patent No. 4183556

### SUMMARY OF INVENTION

### Technical Problem

The aforementioned multi-screen display system includes a plurality of image display devices including media players, wherein each image display device among a plurality of image display devices is able to independently reproduce content. However, the image display devices have their own time information which may be varied in time; hence, the multi-screen display system may suffer from a problem in that it is difficult to perfectly synchronize content when reproduced by image display devices.

Considering the aforementioned problem, the present invention aims to provide a multi-screen display system, an image display device, an image display method, and an image display program, which can reproduce content by establishing synchronization among a plurality of image display devices included in the multi-screen display system.

### Solution to Problem

To solve the above problem, a multi-screen display system according to one aspect of the present invention includes a plurality of image display devices daisy-chained together, wherein the image display device further includes a storage unit configured to store at least the schedule information representing a schedule to reproduce content, and a content reproduction controller configured to start reproducing the content according to the schedule information and the time information of a master image display device corresponding to one of a plurality of image display devices included in the multi-screen display system, and wherein the time information is sent from the master device to another image display device included in the multi-screen display system.

An image display device according to one aspect of the present invention is included in a multi-screen display system including a plurality of image display devices daisy-chained together, wherein the image display device further includes a storage unit configured to store at least the schedule information representing a schedule to reproduce content; a time information receiver configured to receive the time information of a master image display device corresponding to one of a plurality of image display devices included in the multi-screen display system; and a content reproduction controller configured to reproduce the content according to the schedule information and the time information.

An image display method according to one aspect of the present invention is implemented by a computer of an image display device included in a multi-screen display system including a plurality of image display devices daisy-chained together by way of a storing step for a storage unit to store at least the schedule information representing a schedule to reproduce content, a time-information-receiving step for a time information receiver to receive the time information of a master image display device corresponding to one of a plurality of image display devices included in the multi-screen display system, and a content-reproduction-controlling step for a content reproduction controller to reproduce the content according to the schedule information and the time information.

An image display program according to one aspect of the present invention causes a computer of an image display device, which is included in a multi-screen display system including a plurality of image display devices daisy-chained together, to execute a storing step to store at least the schedule information representing a schedule to reproduce content; a time-information-receiving step to receive time information of a master image display device corresponding to one of a plurality of image display devices included in the multi-screen display system; and a content-reproduction-controlling step to reproduce the content according to the schedule information and the time information.

### Advantageous Effects of Invention

According to the present invention, it is possible to reproduce content by establishing synchronization among a plurality of image display devices included in the multi-screen display system.

### BRIEF DESCRIPTION OF DRAWINGS

FIG. 1 is a schematic diagram showing the outline configuration of a multi-screen display system 1a according to one embodiment of the present invention.

FIG. 2 is a table chart describing a configuration example of schedule information s1 stored on an image display device 10 according to one embodiment of the present invention.

FIG. 3 is a schematic diagram showing the outline configuration of a multi-screen display system according to one embodiment of the present invention.

FIG. 4 is a schematic diagram showing delay processes implemented by a multi-screen display system 1b according to one embodiment of the present invention.

FIG. 5 is a block diagram showing the functional configuration of the image display device 10 according to one embodiment of the present invention.

FIG. 6 is a flowchart showing the operation of a master image display device according to one embodiment of the present invention.

FIG. 7 is a flowchart showing the operation of a slave image display device according to one embodiment of the present invention.

FIG. 8 is a schematic diagram showing the outline configuration of a conventional multi-screen display system 5.

FIG. 9 is a schematic diagram showing the outline of a drawing process to display an image on the screen of a generally-known image display device 50.

FIG. 10 is a schematic diagram showing a misalignment of a video which may occur due to a drawing time difference in a conventional multi-screen display system.

### DESCRIPTION OF EMBODIMENTS

Hereinafter, the present invention will be described by way of embodiments, however, the following embodiments do not necessarily limit the scope of the invention defined by claims. In addition, all the combinations of features described in the following embodiments are not necessarily essential in the present invention. In the drawings, the same or similar parts will be denoted by the same reference signs; hence, duplicate descriptions will be omitted here. Moreover, the drawings may overstate elements in their shape and size for the purpose of clearly illustrating elements.

First, the conventional and generally-known multi-screen display system will be described with reference to the drawings.

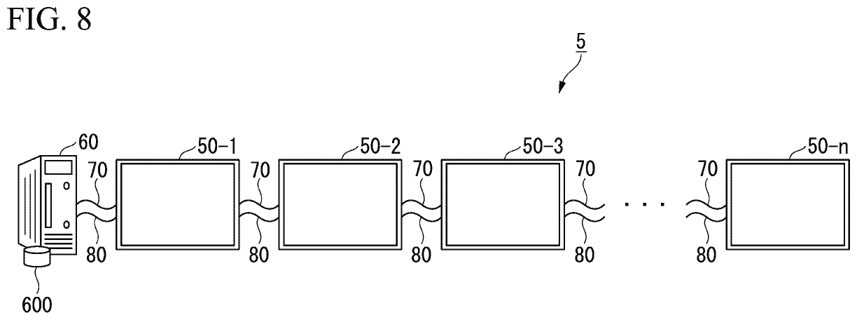

FIG. 8 is a schematic diagram showing the outline configuration of the conventional multi-screen display system 5. As shown in FIG. 8, the multi-screen display system 5 includes n image display devices 50 (i.e. 50-1, 50-2, 50-3, . . . , 50-n), a server 60 including a storage unit 600 configured to store content information or the like, video signal cables 70 configured to daisy-chain n image display devices 50 following the server 60 which is located at the top position, and control cables 80 configured to daisy-chain the n image display devices 50 following the server 60 located at the top position.

For example, the image display device 50 may include a liquid-crystal display (LCD; Liquid Crystal Display), an organic EL (Organic Electroluminescence) display, or a CRT (Cathode Ray Tube).

For example, the server 60 may include a personal computer or a general-purpose computer.

For example, the video signal cable 70 may include a video signal cable such as a HDMI (registered trademark) cable, a DV (registered trademark) cable, and a DisplayPort (registered trademark) cable.

For example, the control cable 80 may include a serial cable such as a LAN (Local Area Network) cable, a RS-232C (Recommended Standard) cable, and a USB (Universal Serial Bus) cable.

The server 60 is configured to transmit a video signal based on content, which is stored on the storage unit 600, to the image display device 50-1 through the video signal cable 70 and to transmit a control signal to the image display device 50-1 through the control cable 80. In this connection, the control signal may indicate a video display method and display timing according to the video signal.

The video signal and the control signal, which are transmitted to the image display device 50-1 from the server 60, are sequentially transmitted in an order of the image display device 50-2, the image display device 50-3, . . . , and the image display device 50-n through the video signal cables 70 and the control cables 80.

Accordingly, the conventional multi-screen display system 5 is able to concurrently display a video based on the content stored on the storage unit 600 of the server 60 by use of a plurality of image display devices 50. In addition, it is possible to display images with the cooperation of the image display devices 50 according to the control signal.

### EMBODIMENT

Now, one embodiment of the present invention will be described below.

[Configuration of Multi-Screen Display System]

Hereinafter, the configuration of the multi-screen display system 1a according to the present embodiment will be described with reference to the drawings.

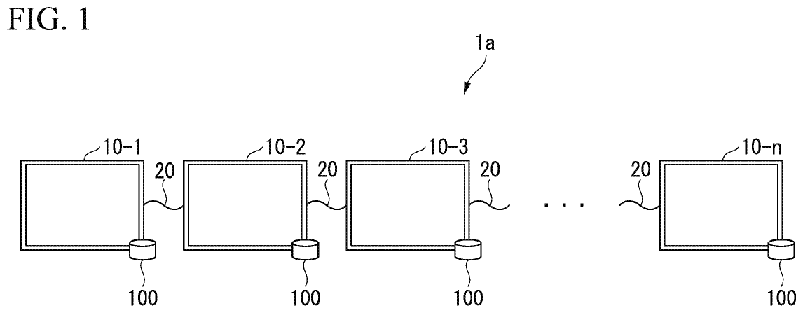

FIG. 1 is a schematic diagram showing the outline configuration of the multi-screen display system 1a according to one embodiment of the present invention. As shown in FIG. 1, the multi-screen display system 1a includes n image display devices 10 (i.e. 10-1, 10-2, 10-3, . . . , 10-n) and control cables 20 configured to daisy chain the n image display devices 10.

Each of the n image display devices 10 further includes a storage unit 100 configured to store content information or the like and a media player (not shown) configured to reproduce videos and sounds based on the content stored on the storage unit 100.

As described above, the multi-screen display system 1 of the present embodiment, in which each of the image display devices 10 includes the content and its media player, does not need the server 60 and the video signal cables 70 which are necessarily installed in the conventional multi-screen display system 5.

In the following descriptions, the image display device 10-1 disposed at the top position among the daisy-chained n image display devices 10 (10-1, 10-2, 10-3, . . . , 10-n) will be referred to as a “master image display device” while the other image display devices 10 (10-2, 10-3, . . . , 10-n) will be each referred to as a “slave image display device”.

Each of the image display devices 10 stores the content and its schedule information indicating a schedule to reproduce the content on the storage unit 100.

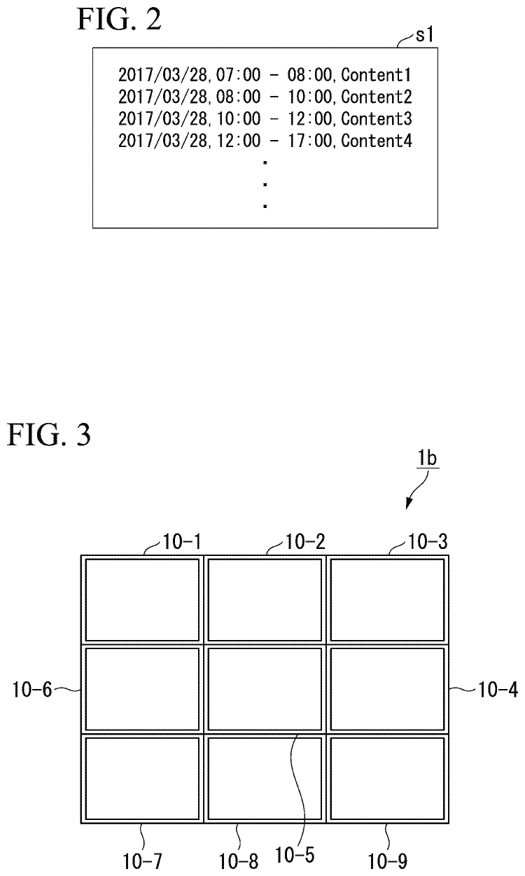

FIG. 2 is a table chart describing a configuration example of schedule information s1 stored in the image display device 10 according to one embodiment of the present invention. As shown in FIG. 2, the schedule information is CSV (Comma-Separated Values) text information describing a plurality of correlated information items separated by commas in a single line.

As shown in FIG. 2, the first-line data of the schedule information s1 indicates “2017/03/28, 07:00-08:00, Content 1”. This data indicates one schedule to reproduce the content assigned an identifier of Content 1 in a time period from 7:00 to 8:00 on Mar. 28, 2017. That is, the schedule information s1 is CSV text information describing the schedule information in each line in which the date to reproduce the content, the time zone to reproduce the content, and the identifier to identify the content to be reproduced are separated by commas.

In the multi-screen display system 1 of the present embodiment, at least the master image display device is configured to check time. Accordingly, the master image display device checks the time to produce the time information, which is transmitted from the master image display device (i.e. the uppermost image display device in the daisy-chain connection) to the lowermost slave image display device in order.

The present embodiment is designed such that the master image display device is selected as the image display device (i.e. the image display device 10-1 in FIG. 1) disposed at the terminal position of the daisy-chain connection; but this is not a restriction. The master image display device may be selected as another image display device (e.g. the image display device 10-2, the image display device 10-3, or other) other than the image display device disposed at the terminal position of the daisy-chain connection.

When the master display device is selected as the image display device 10-2 shown in FIG. 1, for example, the image display device 10-2 serving as the master image display device checks the time to produce the time information, which is delivered to both the image display device 10-1 and the image display device 10-3 serving as the slave image display devices. The time information is transmitted to the image display device 10-3 and then further transmitted to the image display device 10-n in order, and therefore it is possible to transmit the time information to all the slave image display devices included in the multi-screen display system 1.

In the present embodiment, the time information is transmitted from the master image display device to each of slave image display devices at the timing when the master image display device changes the reproduced content. Accordingly, even when the time information is updated during the reproduction of content, for example, it is possible for the multi-screen display system 1 to prevent the occurrence of an operation error.

In this connection, the timing to transmit the time information is not necessarily limited to the aforementioned timing. For example, this timing may be periodical timing (e.g. the timing upon a lapse of a predetermined time such as one hour or one day) or the timing to start the master image display device.

In the multi-screen display system 1a shown in FIG. 1, the time information is transmitted from the image display device 10-1 serving as the master image display device (i.e. the uppermost image display device in the daisy-chain connection) to the image display device 10-n serving as the lowermost image display device in order.

Hereinafter, the other image display device(s) to which the time information has been transmitted before the current image display device (e.g. the image display devices 10-1 and 10-2 before the image display device 10-3) will be referred to as the “upper” image display device(s). In addition, the other image display device(s) to which the time information will be transmitted after the current image display device (e.g. the image display devices 10-3 to 10-n after the image display device 10-2) will be referred to as the “lower” image display device(s).

Hereinafter, the upper-side (or one-stage higher) image display device directly connected to the current image display device through the control cable 20 will be referred to as the “previous-stage” image display device. In addition, the lower-side (or one-stage lower) image display device directly connected to the current image display device through the control cable 20 will be referred to as the “latter-stage” image display device.

All the image display devices 10 (10-1, 10-2, 10-3, . . . , 10-n) included in the multi-screen display system 1 of the present embodiment are each configured to reproduce content stored on the storage unit 100 included in each image display device 10 (10-1, 10-2, 10-3, . . . , 10-n) based on the time information representing the time checked by the master image display device (i.e. the image display device 10-1) and the schedule information stored on the storage unit 100 included in each image display device 10 (10-1, 10-2, 10-3, . . . , 10-n).

In the multi-screen display system 1 having the aforementioned configuration, all the image display devices 10 are each configured to reproduce content according to the time information checked by the master image display device, thus synchronizing the content being reproduced by each of the image display devices 10.

Due to synchronization of content reproduced by each of the image display devices 10, for example, the multi-screen display system 1b is able to enlarge a single-content video to be displayed using a plurality of image display devices 10.

FIG. 3 is a schematic diagram showing the outline configuration of the multi-screen display system 1b according to one embodiment of the present invention. As shown in FIG. 3, the multi-screen display system 1b includes nine image display devices 10 (10-1, 10-2, 10-3, . . . , 10-9).

As shown in FIG. 3, the nine image display devices 10 (10-1, 10-2, 10-3, . . . , 10-n) are aligned in a matrix of three rows by three columns, wherein they are sequentially daisy-chained together in an order counting from the image display device 10-1 to the image display device 10-9 through control cables (not shown).

All the image display devices 10 are configured to store the same content and the same schedule information. All the image display devices 10 are designed such that the current image display device 10 displays the content stored therein according to the time information representing the time checked by the master image display device (i.e. the image display device 10-1) and the schedule information stored in the current image display device 10.

At this time, each of the image display devices 10 enlarges part of an image of content. When an image of content is divided in three rows by three columns, for example, the image display device 10-1 enlarges and displays an upper-left image region on the entire screen thereof. Similarly, the image display device 10-2 enlarges and displays an upper-center image region, which is produced by dividing an image of content in three rows by three columns, on the entire screen thereof. Accordingly, the multi-screen display system 1b is able to enlarge and display an image of content on the entire screen such that the image display devices 10 enlarge and display different regions in an image of content.

Generally speaking, an image display device is configured to sequentially draw and display images in a direction from the upper side to the lower side on the screen.

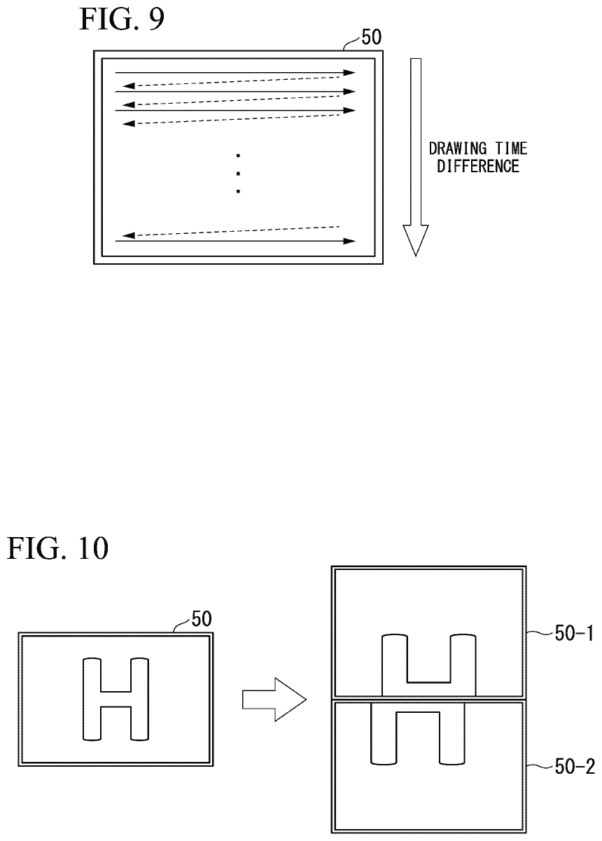

FIG. 9 is a schematic diagram showing the outline of a drawing process to display an image on the screen of a generally-known image display device 50. As shown in FIG. 9, the generally-known image display device 50 scans bright spots (unillustrated) along the uppermost scanning line on the screen in a horizontal direction from the left side to the right side. Next, the image display device 50 scans bright spots again along the one-step lower scanning line in the horizontal direction from the left side to the right side. The image display device 50 repeats this operation to sequentially scan bright spots along the uppermost scanning line to the lowermost scanning line on the screen, thus drawing an image to be displayed on the screen.

Since images are sequentially drawn and displayed on the screen in a vertical direction from the upper side to the lower side, a time difference of drawing images displayed on the screen (hereinafter, referred to as “a drawing time difference”) may occur between the upper position of the screen and the lower position of the screen. For example, an image display device configured to draw a one-screen image (e.g. a one-frame image) in a period of 60 Hz may cause a drawing time difference of about 16.6 milliseconds between the time to draw an image along the uppermost scanning line and the time to draw an image along the lowermost scanning line on the screen.

In the multi-screen display system 1b shown in FIG. 3, for example, a plurality of image display devices 10 vertically adjoining together such as a pair of image display devices 10-1 and 10-6 and a pair of image display devices 10-2 and 10-5 may cause a misalignment (or an intermittence) of a video between the vertically adjoining image display devices due to drawing time differences.

FIG. 10 show a misalignment of a video due to a drawing time difference occurring in the conventional multi-screen display system.

As shown in FIG. 10, an image (e.g. an image including a character “H” in FIG. 10) displayed on the screen of a single image display device 50 is enlarged and displayed using a pair of image display devices 50-1 and 50-2 vertically adjoining together, wherein an intermittence of a video may occur due to a drawing time difference between the timing of drawing along the lowermost scanning line of the image display device 50-1 and the timing of drawing along the uppermost scanning line of the image display device 50-2. In a video in which the character “H” is moving in the leftward direction, for example, a video-intermittence phenomenon may occur such that one part of the character “H” (its lower-half part) displayed on the image display device 50-2 may be moved earlier than another part of the character “H” (its upper-half part) displayed on the image display device 50-1.

It is possible for the multi-screen display system 1b to eliminate the aforementioned video misalignment (or the video intermittence) occurring between the image display devices by updating the time indicated by the time information with an appropriately-delayed time, which will be discussed later.

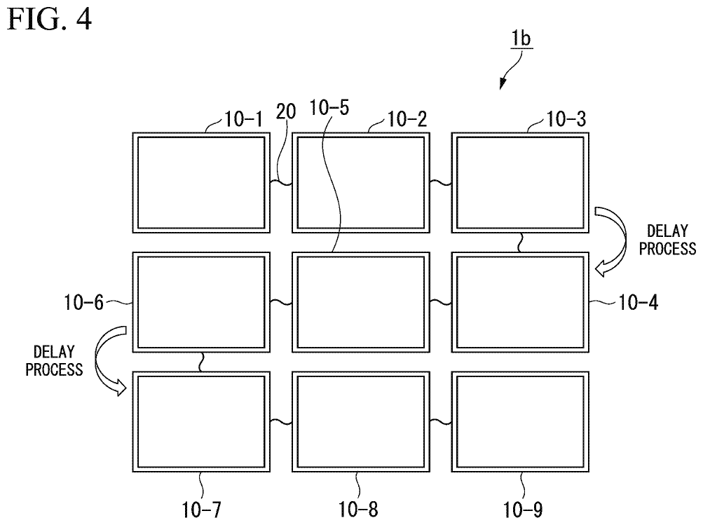

FIG. 4 is a schematic diagram showing delay processes implemented by the multi-screen display system 1b according to one embodiment of the present invention.

As shown in FIG. 4, the multi-screen display system 1b includes nine image display devices 10 (10-1, 10-2, 10-3, . . . , 10-9) which are aligned in three rows by three columns, wherein the image display devices 10-1 to 10-9 are daisy-chained together in order through control cables 20.

In the multi-screen display system 1b, when all the nine image display devices 10 are synchronized to display images on screen according to the time information representing the time checked by the master image display device (i.e. the image display device 10-1), a video-intermittence phenomenon may occur between pairs of image display devices 10 vertically adjoining together (i.e. a pair of image display devices 10-1 and 10-6, a pair of image display devices 10-2 and 10-5, a pair of image display devices 10-3 and 10-4, a pair of image display devices 10-6 and 10-7, a pair of image display devices 10-5 and 10-8, and a pair of image display devices 10-4 and 10-9).

To prevent the occurrence of the aforementioned video-intermittence phenomenon, the multi-screen display system 1b of the present embodiment cause the latter-stage image display device 10 (i.e. the image display device 10-3 and the image display device 10-6), which is aligned beneath the current image display device 10, to carry out a delay process to update the time of the time information with a delayed time which is delayed by a predetermined time.

As described above, when the image display device 10 draws a one-screen image (or a one-frame image) in a period of 60 Hz, for example, a video-intermittence phenomenon may occur due to a drawing time difference of about 16.6 milliseconds between the time of drawing along the uppermost scanning line and the timing of drawing along the lowermost scanning line on the screen. For this reason, the image display devices 10-3 and 10-6 carry out a delay process to update the time of the time information with a delayed time which is delayed by 16.6 milliseconds (or which is delayed by a time of drawing a one-frame image) and then transmit the updated time information to the latter-stage image display devices 10, i.e. the image display devices 10-4 and 10-7.

Accordingly, it is possible for the multi-screen display system 1b of the present embodiment to eliminate a drawing time difference between the timing of drawing along the uppermost scanning line and the timing of drawing along the lowermost scanning line on the screen with respect to all pairs of image display devices 10 vertically adjoining together, and therefore it is possible to prevent the occurrence of the aforementioned video-intermittence phenomenon.

[Functional Configuration of Image Display Device]

Hereinafter, the functional configuration of the image display device 10 according to the present embodiment will be described with reference to the drawings.

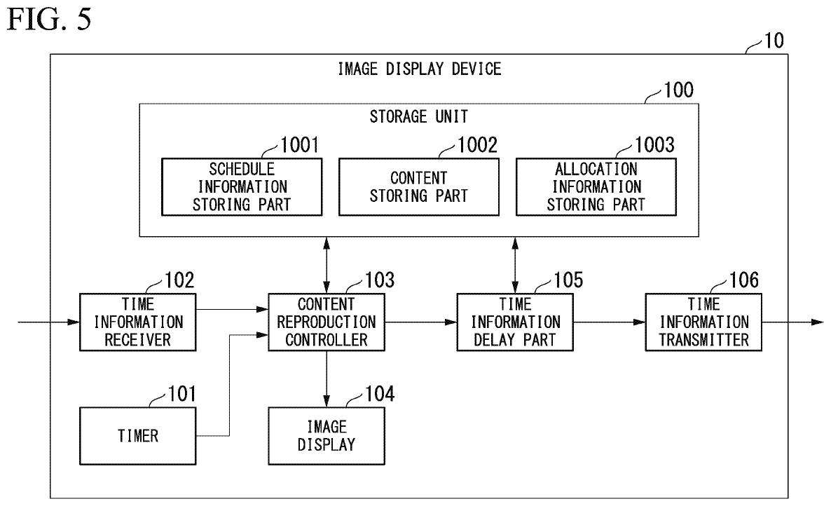

FIG. 5 is a block diagram showing the functional configuration of the image display device 10 according to one embodiment of the present invention. As shown in FIG. 5, the image display device 10 includes a storage unit 100, a timer 101, a time information receiver 102, a content reproduction controller 103, an image display 104, a time information delay part 105, and a time information transmitter 106.

The storage unit 100 is configured to store programs and data used for various processes implemented by the image display device 10. In addition, the storage unit 100 may be used as a temporary storage area temporarily used for various processes implemented by the image display device 10. As the storage unit 100, for example, it is possible to mention storage media, e.g. HDD (Hard Disk Drive), flash memory, EEPROM (Electrically Erasable Programmable Read-Only Memory), RAM (Random-Access read/write Memory), and ROM (Read-Only Memory), as well as arbitrary combinations of storage media.

As shown in FIG. 5, the storage unit 100 includes a schedule information storing part 1001, a content storing part 1002, and an allocation information storing part 1003.

The schedule information storing part 1001 is configured to store the schedule information representing a schedule to reproduce content. In this connection, the schedule information is generated using an authoring tool by a system manager in advance and stored on the schedule information storing part 1001.

The content storing part 1002 is configured to store the content to be reproduced according to the schedule information and the time information in advance. In this connection, the content storing part 1002 may be a portable storage medium connectible from the outside, such as USB (a registered trademark) (Universal Serial Bus) memory and a SD (a registered trademark) memory card, or a built-in storage medium such as RAM embedded in the image display device 10.

The allocation information storing part 1003 is configured to store the allocation information representing an allocated position of the current image display device 10 and an allocated position of the latter-stage image display device 10 which adjoins the current image display device 10 and which communicates with the current image display device 10 through the control cable 20 in the multi-screen display system 1. With reference to the allocation information, the image display device 10 is able to recognize whether the latter-stage image display device 10 is allocated below, above, leftwards, or rightwards of the current image display device 10.

For example, the timer 101 may be a clocking device including an RTC (Real-Time Clock) having a function to continuously count the present time irrespective of a power-off state of the image display device 10. The timer 101 checks the present time to produce the time information representing the checked time, thus sending the time information to the content reproduction controller 103. For example, the time information corresponds to data representing the time checked by the RTC.

When the image display device 10 serving as the slave image display device acquires the time information of the master image display device, the timer 101 of the slave image display device checks its own time information overwritten with the time information of the master image display device. When the slave image display device includes a plurality of RTC information, the slave image display device may store the time information of the master image display device independently of its own time information, thus checking the respective values of time information.

The time information receiver 102 may be a communication interface configured to communicate with the previous-stage image display device 10 through the control cable 20 and to receive the time information representing the time checked by the master image display device from the previous-stage image display device 10. The time information receiver 102 receives the time information and thereby sends the received time information to the content reproduction controller 103.

In this connection, the image display device 10 serving as the master image display device acquires the time information checked by the timer 101 of the master image display device, and therefore the master image display device does not use the function of the time information receiver 102.

The content reproduction controller 103 acquires the time information, representing the time checked by the master image display device, from the time information receiver 102. In addition, the content reproduction controller 103 acquires the schedule information stored on the schedule information storing part 1001 of the storage unit 100. According to the time information and the schedule information, the content reproduction controller 103 acquires the content to be reproduced from the content storing part 1002 of the storage unit 100, thus controlling reproduction of the content to be displayed on the image display device 104 according to a schedule indicated by the schedule information.

The content reproduction controller 103 acquires and sends the time information to the time information delay part 105.

In the image display device 10 serving as the slave image display device, for example, the content reproduction controller 103 corrects a clocking device embedded in the image display device 10 according to the time information acquired from the previous-stage image display device 10. Subsequently, the content reproduction controller 103 starts to reproduce the content at the timing at which the corrected time of a clocking device becomes a content-reproduction start time indicated by the schedule information.

The image display 104 acquires the image data corresponding to the reproduced content from the content reproduction controller 103, and therefore the image display 104 displays an image of image data under the control of the content reproduction controller 103.

For example, the image display 104 may include a display like a liquid-crystal display, an organic EL display, or a CRT.

The time information delay part 105 acquires the time information from the content reproduction controller 103. In addition, the time information delay part 105 acquires the allocation information form the allocation information storing part 1003 of the storage unit 100. The time information delay part 105 recognizes the allocated position of the next-stage image display device 10 serving as a destination to transmit the time information based on the allocation information. Upon recognizing that the latter-stage image display device 10 is allocated beneath the current image display device 10, the time information delay part 105 carries out a delay process to update the time of the time information with a time delayed by a predetermined time. For example, the time information delay part 105 updates the time of the time information with a time delayed by a one-frame drawing time (e.g. 16.6 milliseconds for drawing content in a period of 60 Hz).

In the multi-screen display system 1b shown in FIG. 4, for example, the latter-stage image display device 10 allocated below the current image display device 10 may be the image display device 10-4 against the image display device 10-3 or the image display device 10-7 against the image display device 10-6.

The time information delay part 105 outputs the time information to the time information transmitter 106. In this connection, the time information delay part 105 does not carry out the delay process upon recognizing that the allocated position of the latter-stage image display device 10 is not below the current image display device 10.

The time information transmitter 106 acquires the time information from the time information delay part 105. The time information transmitter 106 is a communication interface configured to communicate with the latter-stage image display device 10 through the control cable 20 and to transmit the time information to the latter-stage image display device 10.

[Operation of Master Image Display Device]

Hereinafter, the operation of the master image display device included in the multi-screen display system 1 (1a, 1b) of the present embodiment will be described with reference to the drawing.

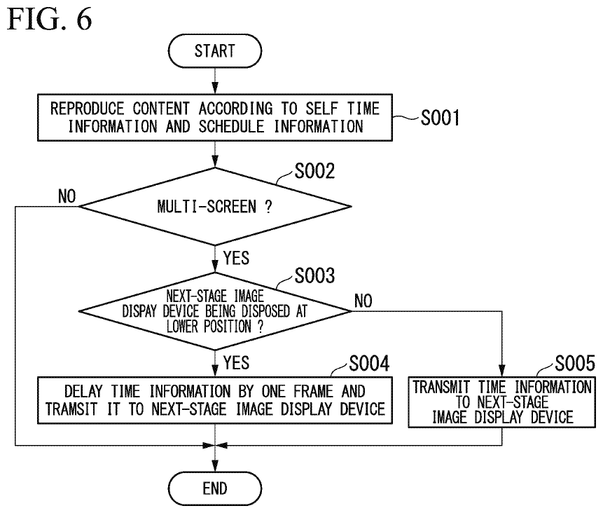

FIG. 6 is a flowchart showing the operation of the master image display device according to one embodiment of the present invention. This flowchart is activated in a power-on event of the master image display device.

(Step S001) The content reproduction controller 103 of the image display device 10 starts to reproduce content stored on the content storing part 1002 according to the time information representing the time checked by the timer 101 of the current image display device 10 and the schedule information stored on the schedule information storing part 1001. Subsequently, the flow proceeds to step S002.

(Step 002) The flow proceeds to step S003 when the multi-screen display system 1 is set such that the image display device 10 should function as one screen among multiple screens. Otherwise, the image display device 10 exits the flowchart.

(Step S003) The time information delay part 105 of the image display device 10 recognizes the allocated position of the latter-stage image display device 10 (i.e. the image display device 10 disposed at a one-stage lower position in the daisy-chain connection which may directly communicate with the current image display device 10 through the control cable 20) serving as a destination to transmit the time information according to the allocation information obtained from the allocation information storing part 1003 of the storage unit 100. The flow proceeds to step S004 when the time information delay part 105 recognizes that the latter-stage image display device 10 is allocated below the current image display device 10. Otherwise, the flow proceeds to step S005.

(Step S004) The time information delay part 105 of the image display device 10 carries out a delay process to update the time of the time information with a time delayed by a predetermined time, thus sending the time information to the time information transmitter 106. The time information transmitter 106 acquires and transmits the time information to the latter-stage image display device 10 through the control cable 20. Then, the image display device 10 exits the flowchart.

(Step S005) The time information delay part 105 of the image display device 10 sends the time information to the time information transmitter 106. The time information transmitter 106 acquires and transmits the time information to the latter-stage image display device 10 through the control cable 20. Thus, the image display device 10 exits the flowchart.

[Operation of Slave Image Display Device]

Hereinafter, the operation of the slave image display device included in the multi-screen display system 1 (1a, 1b) of the present embodiment will be described with reference to the drawing.

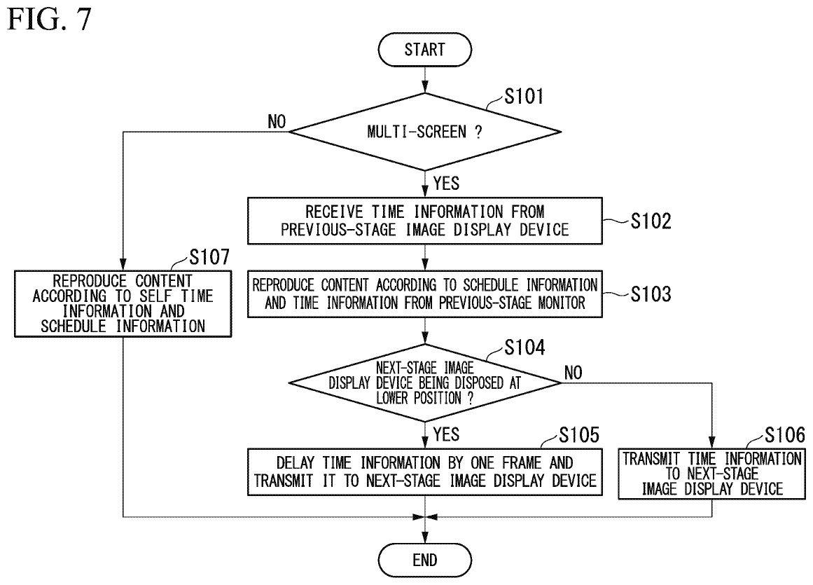

FIG. 7 is a flowchart showing the operation of the slave image display device according to one embodiment of the present invention. This flowchart is activated in a power-on event of the slave image display device.

(Step S101) The flow proceeds to step S102 when the multi-screen display system 1 is set such that the image display device 10 should serve as one screen among multiple screens. Otherwise, the flow proceeds to step S107.

(Step S102) The time information receiver 102 of the image display device 10 receives the time information from the previous-stage image display device 10 through the control cable 20. Subsequently, the flow proceeds to step S103.

(Step S103) The content reproduction controller 103 of the image display device 10 starts to reproduce content stored on the content storing part 1002 according to the time information acquired in step S102 and the schedule information stored on the schedule information storing part 1001. Subsequently, the flow proceeds to step S104.

(Step S104) The time information delay part 105 of the image display device 10 recognizes the allocated position of the latter-stage image display device 10 serving as a destination to transmit the time information according to the allocation information obtained from the allocation information storing part 1003 of the storage unit 100. The flow proceeds to step S105 upon recognizing that the latter-stage image display device 10 is allocated below the current image display device 10. Otherwise (e.g. upon recognizing that the latter-stage image display device 10 is allocated above, leftwards, or rightwards of the current image display device 10), the flow proceeds to step S106.

(Step S105) The time information delay part 105 of the image display device 10 carries out a delay process to update the time of the time information with a time delayed by a predetermined delay time, thus sending the time information to the time information transmitter 106. The time information transmitter 106 acquires and transmits the time information to the latter-stage image display device 10 (i.e. the image display device 10 disposed at a one-stage lower position in the daisy-chain connection which may directly communicate with the current image display device 10) through the control cable 20. In this connection, it is unnecessary to transmit the time information through the control cable 20 due to the absence of the latter-stage image display device 10 (i.e. when the current image display device 10 is disposed at the lowermost position in the daisy-chain connection). Thus, the image display device 10 exits the flowchart.

(Step S106) The time information delay part 105 of the image display device 10 sends the time information to the time information transmitter 106. The time information transmitter 106 acquires and transmits the time information to the latter-stage image display device 10 through the control cable 20. Thus, the image display device 10 exits the flowchart.

(Step S107) The content reproduction controller 103 of the image display device 10 starts to reproduce content stored on the content storing part 1001 according to the time information representing the time checked by the timer 101 of the current image display device 10 and the schedule information stored on the schedule information storing part 1001. Thus, the image display device 10 exits the flowchart.

As described above, the multi-screen display system 1 of the present embodiment controls all the image display devices 10 to reproduce content according to the time information representing the time checked by the master image display device. This may eliminate any variations in the time information acquired by each of the image display devices 10, and therefore the multi-screen display system 1 of the present embodiment is able to synchronize various pieces of content reproduced by the image display devices 10.

In the multi-screen display system 1 of the present embodiment in which two image display devices 10 vertically adjoin together, the previous-stage image display device 10 updates the time of the time information with a time delayed by a one-frame drawing time. Accordingly, it is possible to prevent the occurrence of a video misalignment (or a video intermittence) due to the vertical allocation of the image display devices 10.

Without using expensive frame memory required by conventional display systems, the multi-screen display system 1 of the present embodiment is able to prevent the occurrence of a video-intermittence phenomenon with low cost by simply updating the time of the time information.

Conventionally, it is possible to synchronize time using NTP (Network Time Protocol), i.e. a protocol to synchronize a device clock with an accurate time, with respect to the image display devices 10 connectible to the Internet. However, it is difficult to connect all the image display devices 10 of the multi-screen display system 1 to the Internet due to high cost. In contrast, the multi-screen display system 1 of the present embodiment does not need the Internet connection; hence, it is possible to synchronize time among a plurality of image display devices 10 with low cost.

As described above, the multi-screen display system 1 of the present embodiment includes the image display devices 10 each including content and its media player; hence, it is possible to eliminate the necessity of video signal cables and a server device configured to deliver video signals.

Heretofore, one embodiment of the present invention has been described in detail, however, concrete configurations are not necessarily limited to the foregoing ones; hence, it is possible to introduce various design changes without departing from the subject matter of the invention.

It is possible to realize part of or the entirety of the image display device 10 of the foregoing embodiment using a computer. In this case, it is possible to store programs implementing control functions on computer-readable storage media, and therefore a computer system may load and execute programs stored on storage media to achieve control functions.

In this connection, the term “computer system” refers to a computer system embedded in the image display device 10, which may include an OS and hardware such as peripheral devices. In addition, the term “computer-readable storage media” may refer to flexible disks, magneto-optical disks, ROM, portable media such as CD-ROM, storage devices such as hard disks embedded in computer systems.

In addition, the term “computer-readable storage media” may include any measures configured to dynamically store programs for a short period of time like communication lines such as telephone lines used to transmit programs and networks such as the Internet as well as other measures configured to hold programs for a certain time like volatile memory embedded inside computer systems serving as servers or clients. The foregoing programs may achieve some of the foregoing functions, or they may be combined with pre-installed programs of computer systems to achieve the foregoing functions.

Moreover, the image display device 10 of the foregoing embodiment may be realized using integrated circuitry such as LSI (Large Scale Integration). The image display device 10 includes various functional blocks, which may be realized using processors independently. Alternatively, it is possible to integrate some of the functional blocks or all the functional blocks into processors. In this connection, the technology of making integrated circuitry is not necessarily limited to the LSI technology; hence, it is possible to realize functional blocks using specified circuitry or general-use processors. Due to the advancement of semiconductor technologies, it is possible to use integrated circuitry according to an advanced technology of making integrated circuitry substituting the LSI technology.

Heretofore, the present embodiment of the present invention has been described in detail with reference to the drawings, however, concrete configurations are not necessarily limited to the foregoing embodiment; hence, the present invention may embrace any design changes without departing from the subject matter of the invention.

### REFERENCE SIGNS LIST

1 (1a, 1b) multi-screen display system
5 multi-screen display system
10 (10-1, 10-2, . . . , 10-n) image display device
20 control cable
50 (50-1, 50-2, . . . , 50-n) image display device
60 server
70 video signal cable
80 control cable
100 storage unit
101 timer
102 time information receiver
103 content reproduction controller
104 image display
105 time information delay part
106 time information transmitter
600 storage unit
1001 schedule information storing part
1002 content storing part
1003 allocation information storing part

1. A multi-screen display system comprising a plurality of image display devices daisy-chained together, wherein an image display device among the plurality of image display devices comprises a storage unit configured to store schedule information representing a schedule to reproduce content, and a content reproduction controller configured to start reproducing the content according to the schedule information and time information of a master image display device serving as one of the plurality of image display devices, wherein the time information is sent from the master image display device to a slave image display device serving as another one of the plurality of image display devices.

2. The multi-screen display system according to claim 1, wherein the time information is sent at a timing not to reproduce the content.

3. The multi-screen display system according to claim 1, wherein the time information is sent to the slave image display device at a start timing of the master image display device.

4. The multi-screen display system according to claim 1, wherein the time information is sent from the master image display device to the slave image display device at a timing at which a predetermined time has elapsed.

5. The multi-screen display system according to claim 1, wherein the plurality of image display devices include a former-stage image display device and a latter-stage image display device which adjoin, together, and wherein the image display device further comprises an allocation information storing part configured to store allocation information representing an allocated position of the latter-stage image display device serving as a destination to send the time information, and a time information delay part configured to update a time indicated by the time information with a time delayed by a predetermined time when the allocation information indicates that the allocated position of the latter-stage image display device is disposed below the former-stage image display device.

6. The multi-screen display system according to claim 5, wherein the time information delay part updates the time of the time information with a time delayed by a one-frame drawing time of the former-stage image display device.

7. An image display device among a plurality of image display devices daisy-chained in a multi-screen display system, comprising:
a storage unit configured to store schedule information representing a schedule to reproduce content;
a time information receiver configured to receive time information of a master image display device serving as one of the plurality of image display devices; and
a content reproduction controller configured to reproduce the content according to the schedule information and the time information.

8. The image display device according to claim 7, wherein the plurality of image display devices include a former-stage image display device and a latter-stage image display device which adjoin together, the image display device further comprising an allocation information storing part configured to store allocation information representing an allocated position of the latter-stage image display device serving as a destination to send the time information, and a time information delay part configured to update a time indicated by the time information with a time delayed by a predetermined time when the allocation information indicates that the allocated position of the latter-stage image display device is disposed below the former-stage image display device.

9. The image display device according to claim 8, wherein the time information delay part updates the time of the time information with a time delayed by a one-frame drawing time of the former-stage image display device.

10. An image display method implemented by an image display device among a plurality of image display devices daisy-chained in a multi-screen display system, comprising:
storing schedule information representing a schedule to reproduce content;
receiving time information of a master image display device serving as one of the plurality of image display devices; and
reproducing the content according to the schedule information and the time information.

11. A computer-readable storage medium having stored therein an image display program causing a computer of an image display device among a plurality of image display devices daisy-chained together in a multi-screen display system, to execute:
a storing step to store schedule information representing a schedule to reproduce content;
a receiving step to receive time information of a master image display device serving as one of the plurality of image display devices; and
a reproduction controlling step to reproduce the content according to the schedule information and the time information.
